(19) United States
(12) Patent Application Publication
(10) Pub. No.: US 2008/0154636 A1
(43) Pub. Date: Jun. 26, 2008

(54) Method and system for operation of a multifunctional toyland

(76) Inventor: Margaret Ferrante, Hidden Hills, CA (US)

Correspondence Address: Joseph Farzam, Suite 1345, 1875 Century Park East, Los Angeles, CA, 90067, US

(21) Appl. No.: 11/645,309

(22) Filed: Dec. 26, 2006

(51) Int. Cl. G06Q 50/00

(52) U.S. Cl. 705/2

(57) ABSTRACT

A method and system for operation of a multifunctional Toyland whereby a notification is received from a toy, a child, or a parent telephonically or through the internet and an appointment is scheduled by a receptionist of a non-emergency clinic in the Toyland for various ailments of toys requiring repair, restoration, or replacement. The toy, child, or parent visitor is then provided with a waiting area in the clinic. Later, the toy, child or parent is provided with a evaluation room where various baseline measurements (i.e. condition, size, location of injury, vital signs) of a toy are taken by a nurse to further identify the problem and toys are identified by wristband identification and recorded in the hospital records. Thereafter, the toy, child, or parent is provided with an examination room where toys are examined and evaluated by a physician and the need for diagnostic tests (e.g., x-rays, CAT scan), treatment, and/or referral to a specialist is made and such tests are performed and the physician determines the final toys assessment, and provides a diagnosis and prognosis. Then the toy is provided with an area where it is repaired in an operating room that is observable by parents and children and the toy is repaired, restored, given medication and a follow-up appointment with its clinic doctor. Later, the toy is provided with an area where it is brought in by children or parents in a large “ward” room with many “patient beds” with attached and non-removable accessory equipment (e.g., stethoscopes, blood pressure cuffs and sphygmamoters, thermometers, weight scales) and circulating “Nurses” and Doctors “round” through the area, talking about the “patient” problems and trying to solve them as the “younger” doctors (older children who aspire to become physicians or health care professionals) are “taught” by the real Attending Physician.

### BACKGROUND

(1) Technical Field

The present invention relates generally to operating and managing a children's entertainment facility, and more particularly to a method and system for operation of a multifunctional Toyland.

(2) Discussion

Where does Suzy go when her Raggedy Ann loses an eye? Does her Mom know how to sew on a new button, or otherwise repair it? The doll manufacturers generally do not provide repairs. There are several Internet services available to repair collectible dolls, but generally no physical establishment doll care.

A little child knows that when she is sick, she has to go to the doctor. The doctor fixes her ailment. Little Mary is afraid of shots, she knows about the bandages, boo-boos, and kisses that make them feel better. While she can apply all these aids to her favorite doll, nonetheless, the doll's missing button, broken arm, or stomach ache remains. But what if a child could take her doll to the Toy Pharmacy, the Toy Doctor, to the Toy Hospital, or to the Toy Emergency Room? What is unique about the concept?

In the Toy Pharmacy, mother or father may help little Joey pick out bandaids or stomachache remedies for his doll. Little Joey may not want to take his doll to the hospital, which is in the same building. But if the doll becomes more ill, little Joey may be ready to take the doll to the Toy Hospital on the next visit. The uniqueness lies in the sequential exposure that Joey has to taking his doll to the Toy Hospital, and in Joey's being in control of his own experience with the Toy Hospital.

Some children rarely visit the doctor, other than for shots. Older children or children with disabilities, deformities, or diseases are quite aware of the intricacies of a hospital and of their own disease, of doctors wearing white doctor coats, of the iv needle, the smell of alcohol, of people wearing masks and gloves and Chemotherapy. These children play “sick” with their dolls, but have no where to take their “ill” dolls when they need a Toy Hospital. Nor do they have a place that the child can visit with their doll first, so that for example, dolly can go “take her cast off” first, before Molly or Joe has to go get his cast off. Herein lies the uniqueness of the Toy Hospital, which provides all these experiences in a nonconfrontational manner that allows a child to ‘play’ hospital, through his doll. There are two main projections about the benefit of the Toy Hospital that make it particularly unique by specifically following an authentic medical model of care. One involves “seeing” first before “doing”. Real doctors are taught to become doctors by the following method: “See one, do one, teach one”. A child watches his doll ‘patient’ undergo medical therapy that he himself is scheduled to undergo. The child ‘sees’ the doll undergo a medical experience that is unknown to the child. Later, the child may undergo that experience himself, being more comfortable about it because he has seen it once. Then perhaps, he is able to help another child go through it.

The other involves “caring”, allowing a child to become the doll ‘parent’ so that nurturing and caring for another is encouraged. The child feels in control of the doll ‘patient’s situation, experiences it simultaneously with the doll, and leaves the Toy Hospital with confidence about the experience. Armed with knowledge and experience, he is less fearful about being around a doctor and about being in a hospital.

‘Doll therapy’, wherein a child play-acts through his or her doll, is yet another angle of potential benefit. Many studies have shown the benefits of “play therapy” with children psychiatrists and psychologists (1), who are able to extract information from children through play therapy. Through play therapy, a child can express his fears and loneliness about a real situation. Having a real medical doctor on staff will allow for a unique assessment of any medical or psychological issues, should the need arise. A psychotherapist or psychiatrist may assist in this endeavor.

The unique benefits of having little Charlie “see first” what happens when his doll goes in for “chemotherapy” may have significant psychological benefits for Charlie later, when he himself goes to his hospital for his own chemotherapy. He will have been in the Toy Hospital dormitory bed with his doll. He had the doctors and nurses “round” on his doll and the other doll “patients”, take the doll's blood pressure, and weight, determine the proper therapy, and insert play intravenous bags of fluid. The doll may “throw up”, get special medicine, and eventually walk out of the Toy Hospital. Now, when Charlie goes in to his hospital for his own chemotherapy, he will have a sense of understanding what is going to happen, the sequence of particular events, and that he will leave the hospital. Importantly, his doll will have been through its own chemotherapy first, so now they have a special bond.

A Toy Hospital admission occurs similarly to a real hospital, uniquely allowing a child to experience a hospital without being a patient. Suzie's doll must see the Toy Doctor. Much like a mother taking in her own child, Suzie tells the receptionist what her doll's ailment is. Much like a real hospital, the receptionist “triages” the doll to receive either urgent, or nonurgent care. Eventually, the doll sees a doctor; the ‘mother’ answers questions about how the accident or ailment occurred (a patient “history”). The doctor also asks about related issues: appetite and sleep patterns, for example (a patient “review of systems”). Next comes the “physical exam” portion, whereby the doctor gathers yet more information. The doctor may order, “studies, laboratories, or tests” to further assist in determining a “diagnosis”. Once a diagnosis or assessment is made, the “plan”, including any prescriptions or treatments is determined. The doll is referred to specialists as needed, and/or for return follow-up as needed. Sometimes an “ambulance” call results in an emergent doll arriving for definitive therapy, with bells and whistles galore. Doctors keep a chart on each ‘patient’, in case he or she returns for additional care. If hospitalization is needed for any doll, the following occurs:

The doll, accompanied by the ‘parent’ child, lies on a bed in the Toy Dormitory. Each bunk bed in the Toy Dormitory style room houses an ill doll with their ‘parent’ children. There are about 10 dolls per room. While dolls are waiting for the doctor to arrive, the ‘parent’ child may play with stethoscopes and other medical supplies. Once the doctor appears with the staff, which includes training physicians (i.e., older children that want to play doctor) in a group together, they begin “rounding” on the patients. Starting at bed one, they discuss the doll's problems, asking questions of the parent as needed. Once the plan is made, they may or may not discuss particulars with the child. A “nurse” rounds with the team, and goes back to explain all to the parents, if needed. From this room, the doll may go to one of several places. Sometimes the doll stays for a while and then goes home well. Sometimes the doll goes to another part of the Toy Hospital for further tests (the ‘parent’ can sometimes follow), and then comes back. Sometimes the doll goes to surgery (the ‘parent’ can then watch the operation through a glass window), or has to be transferred to another hospital (i.e., for repair). Sometimes the doll just passes away and then becomes available for the mortuary.

Older siblings, especially those who aspire to go into a medical profession, may participate on ‘patient rounds’ by dressing in a white coat, ‘pre-rounding’ on every ‘patient, explaining to the Attending Physician what each ‘patient’s problem is, then assisting in carrying out the individual ‘plan’. This may include assisting with transporting ‘patients’ for further studies, mixing intravenous chemotherapy, and assisting with cast removal.

After the Toy Hospital visit, everyone is hungry. The family may choose to eat in the Toy Dining Hall. Here, families sit on park bench seating. The menu consists of all child-sized sandwiches cookies, and drinks. It is a Child's Menu, with a small Parent's Menu on the side. Raggedy Ann and Andy are table servers. With each seating, a live show is performed on the second floor balcony that oversees the dining hall, as a musical with audience participation.

The Toy Land may be operated in an Amusement-style Park, with a central Hospital for Toys and their Children/Parents to visit when Toys become sick or disabled as well as other amenities for a child, a Toy and the accompanying parent. The following is a list of other potential amenities:
1. Toyland Veterinary Hospital: for all ailing animal toys. Repair, restoration, demise, and/or replacement possible.
2. Toyland Barber Shop: emphasis boy/male Toy hair styling. Repair, restoration, and/or replacement possible.
3. Toyland Shoe Shine: emphasis toy shoe shines. Available to Toys and their Children/Parents.
4. Toyland Beauty Salon: emphasis girl/female hair, facial, skin, and nail care for Toys and their Children. Facials and nail care are also available to Parents.
5. Toyland Bakery: emphasis child-sized cookies and bakery items, with display and sizes for child's eyes and hands.
6. Toyland Pharmacy: emphasis Toy items, first aid kits, hospital and veterinary hospital toys, artistry items for children.
7. Toyland Church: emphasis prayer, baptisms, and funerals.
8. Toy Library: emphasis health care of Toys and their Children/Parents. Toy/Children murals, child sized book shelving and reading areas.
9. Toyland Theatre: child sized seating and refreshments; children's rated G classic movies.
10. Toyland Park: Toy and child sized play equipment and garden area. Children may “walk” their dog/animal through the park.
11. Toyland Grocery Store: emphasis Toy shopping with Child, area for Toy to be placed in cart, child sized shelving and grocery items.
12. Toyland Hotel: Toys and their Children/Parents reside in this full-service hotel, which is on site. Includes child-sized furniture, child-sized room service foods (including Toyland Bakery items), and child-sized playground.
13. Toyland Tailor: Dolls are fitted for clothing of choice. The child selects from various patterns and colors of fabric and various styles of clothing and the doll is measured and clothing is custom-tailored for the doll.

### SUMMARY

The present invention is a method and system for operation of a multifunctional Toyland whereby a notification is received from a toy, a child, or a parent telephonically or through the internet and an appointment is scheduled by a receptionist of a non-emergency clinic in the Toyland for various ailments of toys requiring repair, restoration, or replacement. The toy, child, or parent visitor is then provided with a waiting area in the clinic. Later, the toy, child or parent is provided with a evaluation room where various baseline measurements (i.e. condition, size, location of injury, vital signs) of a toy are taken by a nurse to further identify the problem and toys are identified by wristband identification and recorded in the hospital records. Thereafter, the toy, child, or parent is provided with an examination room where toys are examined and evaluated by a physician and the need for diagnostic tests (e.g., x-rays, CAT scan), treatment, and/or referral to a specialist is made and such tests are performed and the physician determines the final toys assessment, and provides a diagnosis and prognosis. Then the toy is provided with an area where it is repaired in an operating room that is observable by parents and children and the toy is repaired, restored, given medication and a follow-up appointment with its clinic doctor. Later, the toy is provided with an area where it is brought in by children or parents in a large “ward” room with many “patient beds” with attached and non-removable accessory equipment (e.g., stethoscopes, blood pressure cuffs and sphygmamoters, thermometers, weight scales) and circulating “Nurses” and Doctors “round” through the area, talking about the “patient” problems and trying to solve them as the “younger” doctors (older children who aspire to become physicians or health care professionals) are “taught” by the real Attending Physician.

In a further embodiment, in the Toyland the toy, child, or parent is provided with a “triage” Emergency Room for immediate description of a problem and an assignment of severity of the problem and immediacy of care needed where Toys and their Children then sit in the waiting room until called. Thereafter, the toy is taken to an Evaluation area, where various baseline measurements of the Toy (i.e., condition, size/location of injury) and “vital signs” are taken by a “nurse”, to further define the problem. Later, the toy is personally examined and evaluated by a real physician to asses the need for diagnostic tests (e.g., x-rays, CAT scan), treatment, and/or referral to a specialist. Then, a final assessment of the toy is made and the toy is provided with a diagnosis and prognosis by the physician. Thereafter, the toy is repaired in the Evaluation Room, and/or the Operating Room, given “medication”, and/or given a follow-up appointment with its Clinic doctor.

### DETAILED DESCRIPTION

The present invention relates generally to operating and managing a children's entertainment facility, and more particularly to a method and system for operation of a multifunctional Toyland. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

1. Introduction

The present invention is a method and system for operation of a multifunctional Toyland whereby a notification is received from a toy, a child, or a parent telephonically or through the internet and an appointment is scheduled by a receptionist of a non-emergency clinic in the Toyland for various ailments of toys requiring repair, restoration, or replacement. The toy, child, or parent visitor is then provided with a waiting area in the clinic. Later, the toy, child or parent is provided with a evaluation room where various baseline measurements (i.e. condition, size, location of injury, vital signs) of a toy are taken by a nurse to further identify the problem and toys are identified by wristband identification and recorded in the hospital records. Thereafter, the toy, child, or parent is provided with an examination room where toys are examined and evaluated by a physician and the need for diagnostic tests (e.g., x-rays, CAT scan), treatment, and/or referral to a specialist is made and such tests are performed and the physician determines the final toys assessment, and provides a diagnosis and prognosis. Then the toy is provided with an area where it is repaired in an operating room that is observable by parents and children and the toy is repaired, restored, given medication and a follow-up appointment with its clinic doctor. Later, the toy is provided with an area where it is brought in by children or parents in a large “ward” room with many “patient beds” with attached and non-removable accessory equipment (e.g., stethoscopes, blood pressure cuffs and sphygmamoters, thermometers, weight scales) and circulating “Nurses” and Doctors “round” through the area, talking about the “patient” problems and trying to solve them as the “younger” doctors (older children who aspire to become physicians or health care professionals) are “taught” by the real Attending Physician.

(2) Discussion

A notification is received from a toy, a child, or a parent telephonically or through the internet and an appointment is scheduled by a receptionist of a non-emergency clinic in the Toyland for various ailments of toys requiring repair, restoration, or replacement.

The toy, child, or parent visitor is then provided with a waiting area in the clinic. Later, the toy, child or parent is provided with an evaluation room where various baseline measurements (i.e. condition, size, location of injury, vital signs) of a toy are taken by a nurse to further identify the problem and toys are identified by wristband identification and recorded in the hospital records.

Thereafter, the toy, child, or parent is provided with an examination room where toys are examined and evaluated by a physician and the need for diagnostic tests (e.g., x-rays, CAT scan), treatment, and/or referral to a specialist is made and such tests are performed and the physician determines the final toys assessment, and provides a diagnosis and prognosis.

Then the toy is provided with an area where it is repaired in an operating room that is observable by parents and children and the toy is repaired, restored, given medication and a follow-up appointment with its clinic doctor.

Later, the toy is provided with an area where it is brought in by children or parents in a large “ward” room with many “patient beds” with attached and non-removable accessory equipment (e.g., stethoscopes, blood pressure cuffs and sphygmamoters, thermometers, weight scales) and circulating “Nurses” and Doctors “round” through the area, talking about the “patient” problems and trying to solve them as the “younger” doctors (older children who aspire to become physicians or health care professionals) are “taught” by the real Attending Physician.

In a further embodiment, in the Toyland the toy, child, or parent is provided with a “triage” Emergency Room for immediate description of a problem and an assignment of severity of the problem and immediacy of care needed where Toys and their Children then sit in the waiting room until called.

Thereafter, the toy is taken to an Evaluation area, where various baseline measurements of the Toy (i.e., condition, size/location of injury) and “vital signs” are taken by a “nurse”, to further define the problem.

Later, the toy is personally examined and evaluated by a real physician to asses the need for diagnostic tests (e.g., x-rays, CAT scan), treatment, and/or referral to a specialist.

Then, a final assessment of the toy is made and the toy is provided with a diagnosis and prognosis by the physician.

Thereafter, the toy is repaired in the Evaluation Room, and/or the Operating Room, given “medication”, and/or given a follow-up appointment with its Clinic doctor.

What is claimed is:

1. Method and system for operation of a multifunctional Toyland comprising the steps of:
a. Receiving a notification from a toy, a child, or a parent telephonically or through the internet and scheduling an appointment by a receptionist of a non-emergency clinic in the Toyland for various ailments of toys requiring repair, restoration, or replacement;
b. Providing the toy, child, or parent visitor with a waiting area in the clinic;
c. Providing the toy, child, or parent with a evaluation room where various baseline measurements (i.e. condition, size, location of injury, vital signs) of a toy are taken by a nurse to further identify the problem and toys are identified by wristband identification and recorded in the hospital records;
d. Providing the toy, child, or parent with an examination room where toys are examined and evaluated by a physician and the need for diagnostic tests (e.g., x-rays, CAT scan), treatment, and/or referral to a specialist is made and such tests are performed and the physician determines the final toys assessment, and provides a diagnosis and prognosis;
e. Providing an area where toys are repaired in an operating room that is observable by parents and children and toys are repaired, restored, given medication and a follow-up appointment with their clinic doctor.
f. Providing an area where toys are brought in by children or parents in a large “ward” room with many “patient beds” with attached and non-removable accessory equipment (e.g., stethoscopes, blood pressure cuffs and sphygmamoters, thermometers, weight scales) and circulating “Nurses” and Doctors “round” through the area, talking about the “patient” problems and trying to solve them as the “younger” doctors (older children who aspire to become physicians or health care professionals) are “taught” by the real Attending Physician;

2. A method and system for operation of a multifunctional Toyland, as set forth in claim 1, whereby the Toyland further comprises the step of providing the toy, child, or parent visitor with a “triage” Emergency Room for immediate description of a problem and an assignment of severity of the problem and immediacy of care needed where Toys and their Children then sit in the waiting room until called;

3. A method and system for operation of a multifunctional Toyland, as set forth in claim 2, whereby the Toyland further comprises the step of taking the Toy, child, or parent visitor to the Evaluation area, where various baseline measurements of the Toy (i.e., condition, size/location of injury) and “vital signs” are taken by a “nurse”, to further define the problem;

4. A method and system for operation of a multifunctional Toyland, as set forth in claim 3, whereby the Toyland further comprises the step of personally examining and evaluating the Toy, child, or parent visitor by a real physician to asses the need for diagnostic tests (e.g., x-rays, CAT scan), treatment, and/or referral to a specialist;

5. A method and system for operation of a multifunctional Toyland, as set forth in claim 4, whereby the Toyland further comprises the step of determining the final Toy, child, or parent visitor assessment, and providing a diagnosis and prognosis by the physician;

6. A method and system for operation of a multifunctional Toyland, as set forth in claim 5, whereby the Toyland further comprises the step of repairing the Toy in the Evaluation Room, and/or the Operating Room, given “medication”, and/or given a follow-up appointment with their Clinic doctor.
